(19) United States
(12) Patent Application Publication
(10) Pub. No.: US 2004/0233192 A1
(43) Pub. Date: Nov. 25, 2004

(54) Focally-controlled imaging system and method

(76) Inventor: Stephen A. Hopper, Denton, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/443,931

(22) Filed: May 22, 2003

(51) Int. Cl. G06T 15/00

(52) U.S. Cl. 345/419

(57) ABSTRACT

A focally-controlled imaging system comprises a tracking system adapted to monitor a spatial focal point of a user and a virtual imager adapted to generate a virtual representation of an object for display to the user. The virtual imager is adapted to focalize the virtual representation corresponding to the spatial focal point of the user.

### TECHNICAL FIELD OF THE INVENTION

The present invention relates generally to the field of imaging systems and, in particular, to a focally-controlled imaging system and method.

### BACKGROUND OF THE INVENTION

Three-dimensional imaging systems, such as virtual reality, holographic, and other types of imaging systems, are used in a relatively wide array of applications. For example, three-dimensional imaging systems may comprise an enclosure, a flat-panel, a head-mounted display device or other type of display environment or device for displaying a three-dimensional representation of an object or image to a viewer. The viewer generally wear a tracking device, such as a head-mounted tracking device, to determine a viewing orientation of the viewer relative to the displayed object or images. Based on the viewing orientation of the viewer, three-dimensional representation images are displayed on the display device or environment.

Three-dimensional imaging systems may also provide overlay information of a user or observer such that additional information is superimposed over other graphical information. For example, a transparent two-dimensional interface object may be superimposed over other graphical information via a head-mounted display device or other type of device or display environment. The interface may provide additional information relating to the underlying images or provide the user with feature options relating to the underlying images.

However, present three-dimensional imaging systems generally provide the graphical information to a user or observer based on a fixed point in space relative to the user or the underlying graphical information. For example, when superimposing two-dimensional interface objects over other graphical information, the interface object is generally presented at a predefined point in space relative to the user's field of view. Thus, the superimposed information may be difficult to discern from the underlying graphical information. Additionally, spatial distinctions within the underlying three-dimensional information generally require head movement of the user or observer so that an associated head-tracking device signals a change of viewing direction.

### SUMMARY OF THE INVENTION

A need has arisen to solve visual shortcomings and limitations associated with present three-dimensional imaging systems.

In accordance with an embodiment of the present invention, a focally-controlled imaging system comprises a tracking system adapted to monitor a spatial focal point of a user and a virtual imager adapted to generate a virtual representation of an object for display to the user. The virtual imager is adapted to focalize the virtual representation corresponding to the spatial focal point of the user.

In accordance with another embodiment of the invention, a focally-controlled imaging method comprises obtaining tracking data corresponding to a spatial focal point of a user and generating a virtual representation of an object for display to the user. The method also comprises focalizing the virtual representation corresponding to the spatial focal point of the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a diagram illustrating an embodiment of a focally-controlled imaging system in accordance with the present invention;

FIG. 2 is a flow chart illustrating an embodiment of a focally-controlled imaging method in accordance with the present invention; and

FIG. 3 is a flow chart illustrating another embodiment of a focally-controlled imaging method in accordance with the present invention.

### DETAILED DESCRIPTION OF THE DRAWINGS

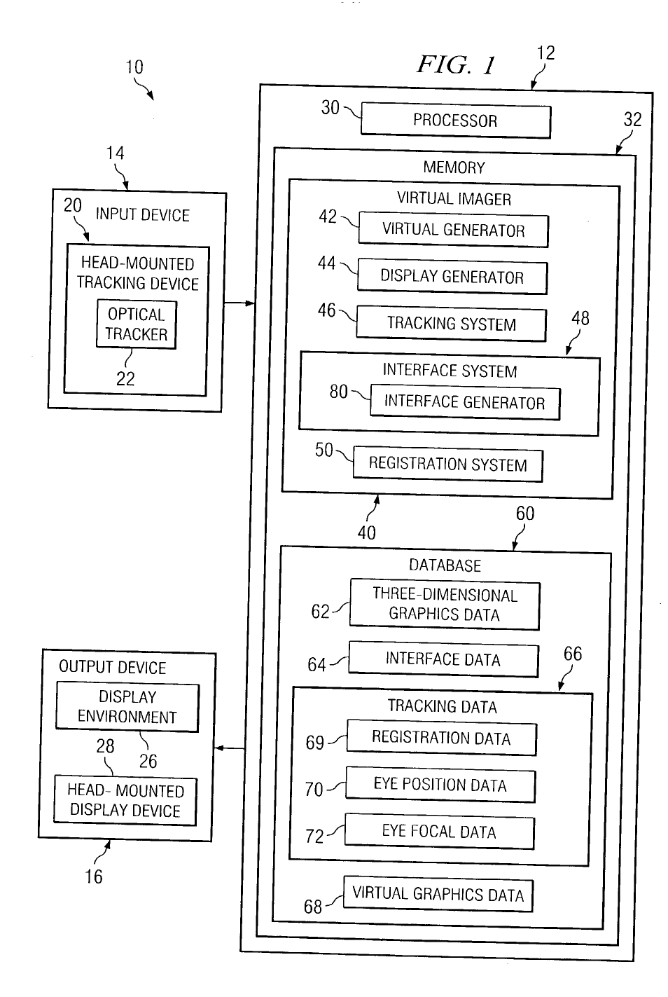

The preferred embodiment of the present invention and its advantages are best understood by referring to FIGS. 1-3 of the drawings, like numerals being used for like and corresponding parts of the various drawings.

FIG. 1 is a diagram illustrating an embodiment of a focally-controlled imaging system 10 in accordance with the present invention. Briefly, system 10 provides graphical information to a user or observer in a three-dimensional or virtual representation format and modifies or otherwise manipulates the displayed graphical information corresponding to a focal point of the user. For example, three-dimensional graphical information is displayed to a user via a head-mounted device, display environment, or other type of display medium, and changes to the displayed graphical information are based on a focal point of the user. The focal point of the user is determined by analyzing eye movements of the user, thereby causing a focalization of particular areas of the displayed graphical information. Additionally, various interfaces may be displayed to the user superimposed over the three-dimensional graphical images that may be highlighted or otherwise focalized based on a focal point of the user, thereby creating a less distracting three-dimensional or virtual environment.

In the embodiment illustrated in FIG. 1, system 10 comprises a virtual controller 12, an input device 14, and an output device 16. Briefly, virtual controller 12 receives information from input device 14 and generates a virtual representation of an object for viewing by an observer or user. The displayed virtual representations may comprise any object such as, but not limited to, a stored action simulation (i.e., video game simulation and/or drive/fly/test simulation), a virtual representation of a presently occurring event, or a static or dynamic design model.

Input device 14 provides information to virtual controller 12 to enable real-time changes to the displayed virtual representations based on a focal point of the user. For example, in the embodiment illustrated in FIG. 1, input device 14 comprises a head-mounted tracking device 20 having an optical tracker 22 for acquiring information relating to a user's eyes for determining a focal point of the user. For example, optical tracker 22 may be configured to employ pattern recognition or other methodologies to distinguish a position of the pupil of each eye of the user and associated coordinates to enable virtual controller 12 to determine and identify a spatial focal point of the user. In the embodiment illustrated in FIG. 1, a head-mounted tracking device 20 is used to monitor and acquire information corresponding to the positions of the user's eyes; however, it should be understood that other types of devices, user-mounted or otherwise, may be used to acquire information relating to the user's eyes for determining a spatial focal point of the user's eyes.

Output device 16 may comprise any device for providing or displaying information received by virtual controller 12 to a user. For example, in the embodiment illustrated in FIG. 1, output device 16 comprises a display environment 26 and a head-mounted display device 28. Display environment 26 may comprise a plurality of screens or other display surfaces for creating a virtual environment for viewing the virtual representations generated by virtual controller 12. However, display environment 26 may also comprise other types of devices or environments such as, but not limited to, a desk-top or desk-type platform for viewing the virtual representations generated by virtual controller 12. Head-mounted display device 28 may be any device wearable by the user for displaying the three-dimensional virtual representations generated by virtual controller 12 to the user.

In FIG. 1, virtual controller 12 comprises a processor 30 and a memory 32. Virtual controller 12 also comprises a virtual imager 40. In FIG. 1, virtual imager 40 is illustrated as being stored in memory 32 so as to be accessible and executable by processor 30. However, it should be understood that virtual imager 40 may be otherwise stored, even remotely, so as to be accessible by processor 30. Virtual imager 40 may comprise software, hardware, or a combination of software and hardware for generating, manipulating, and controlling virtual representations to be presented to the user via output device 16.

In the embodiment illustrated in FIG. 1, virtual imager 40 comprises a virtual generator 42, a display generator 44, a tracking system 46, an interface system 48, and a registration system 50. Virtual generator 42, display generator 44, tracking system 46, interface system 48, and registration system 50 may comprise software, hardware, or a combination of software and hardware. Briefly, virtual generator 42 generates the virtual representations to be displayed to the user via output device 16. Display generator 44 controls the display of the virtual representations generated by virtual generator 42 to a user via output device 16. For example, display environment 26 may comprise multiple screens such that display generator 44 coordinates presentation of the three-dimensional virtual representations on each screen to create a virtual environment for the user. Tracking system 46 receives information from input device 14 and determines a spatial focal point of the user from the received information. Interface system 48 generates one or more interfaces or presentation to the user via output device 16 such as, but not limited to, planar two-dimensional transparent data presentation screens. Registration system 50 correlates actual eye positions of the user with a spatial focal point based on a series of acquired eye position data points, thereby providing a learning platform for determining spatial focal patterns of the user's eyes.

In FIG. 1, virtual controller 12 also comprises a database 60 having three-dimensional graphics data 62, interface data 64, tracking data 66, and virtual graphics data 68. Three-dimensional graphics data 62 comprises information associated with three-dimensional models or other data to be presented or displayed as virtual three-dimensional representation images to the user via output device 16. For example, three-dimensional graphics data 62 may comprise information associated with a three-dimensional model of a room, car, or outdoor environment such that a virtual representation of the model may be generated and displayed to the user via output device 16. Interface data 64 comprises information associated with one or more displayable interfaces for providing additional information to the user via output device 16. For example, interface data 64 may comprise information associated with or contained within transparent two-dimensional planar windows displayed to the user via output device 16.

Tracking data 66 comprises information associated with generating and modifying a virtual representation of three-dimensional graphics data 62 based on a spatial focal point of the user. For example, in the embodiment illustrated in FIG. 1, tracking data 66 comprises registration data 69, eye position data 70 and eye focal data 72. Registration data 69 comprises information associated with correlating eye positions of the user with particular spatial focal points of the user. For example, registration data 69 may comprise relational information correlating spatial focal points of the user to eye positions of the user acquired by registration system 50. Eye position data 70 comprises information associated with the position of the user's eyes acquired by optical tracker 22 and stored in memory 32 as eye position data 70. Eye focal data 72 comprises information associated with identifying a spatial focal point of the user based on eye position data 70. Virtual graphics data 68 comprises information associated with the virtual representation images generated by virtual generator 42 for display to the user via output device 16. In FIG. 1, tracking data 66 and virtual graphics data 68 are illustrated as being stored in database 60. However, it should be understood that tracking data 66, such as eye position data 70 and eye focal data 72, and virtual graphics data 68 may be only temporarily stored or generated and displayed in real-time, thereby obviating a need to store the information in database 60. Thus, the illustration of tracking data 66 and virtual graphics data 68 may be for reference only to clarify or otherwise define operations performed on various types of data.

In operation, tracking data 66, such as eye position data 70, is acquired in real time by optical tracker 22 and transmitted to virtual controller 12 via wired or wireless communications networks. Registration data 69 may be acquired via registration system 50 and used to correlate eye position data 70 to particular spatial focal points of the user, as indicated in FIG. 1 by eye focal data 72. For example, the user may be requested to focus on a series of predetermined or predefined spatial locations relative to the user such that registration data 69 may be acquired corresponding to the known spatial locations. Thus, after information associated with a predetermined quantity of spatial coordinates has been collected, registration data 69 may be used to correlate real time acquired eye position data 70 to spatial focal points of the user to determine eye focal data 72 corresponding to a particular eye position of the user.

Virtual generator 42 is then used to generate virtual graphics data 68 based on three-dimensional graphics data 62 and eye focal data 72. For example, virtual graphics data 68 comprises the three-dimensional image representations of an object as indicated by three-dimensional graphics data 62 such that the representation images generated by virtual generator 42 are modified corresponding to a focal point of the user as indicated by eye focal data 72. Thus, the generated visual representations displayed to the user include focalized portions corresponding to the focal point of the user as well as non-focalized portions, such as peripheral vision areas.

After virtual graphics data 68 generation by virtual generator 42, display generator 44 controls the display of the three-dimensional image representations on output device 16. For example, if output device 16 comprises display environment 26 having a plurality of screens or walls creating a virtual environment about the user, display generator 44 controls the images displayed on each corresponding screen or wall to create the virtual environment about the user.

Interface system 48 may be used to generate one or more data interface screens for display to the user via output device 16. For example, an interface data screen may comprise an icon, a transparent two-dimensional screen containing data viewable by the user, or another type of visual display object superimposed over the three-dimensional representation images of virtual graphics data 68 displayed via output device 16. Thus, in operation, interface system 48 may access interface data 64 having information associated with the size of a particular interface data screen, the data to be displayed on each interface data screen, and a spatial location for display of the interface data screen to the user. In operation, virtual generator 42 displays the interface data screens to the user via output device 16 and monitors eye focal data 72. In response to a change in eye focal data 72 corresponding to a particular interface, interface system 48 may automatically modify the visual representation of the interface. For example, in the illustrated embodiment, interface system 48 comprises an interface generator 80 that may be used to focalize the interface based on eye focal data 72 such that each interface data screen may be focalized in response to a spatial focal point of the user's eyes. Thus, as the focal position of the user's eyes change, virtual generator 42 automatically focalizes and/or un-focalizes portions of virtual graphics data 68 and interface generator 80 automatically focalizes a particular interface data screen corresponding to the user's focal point.

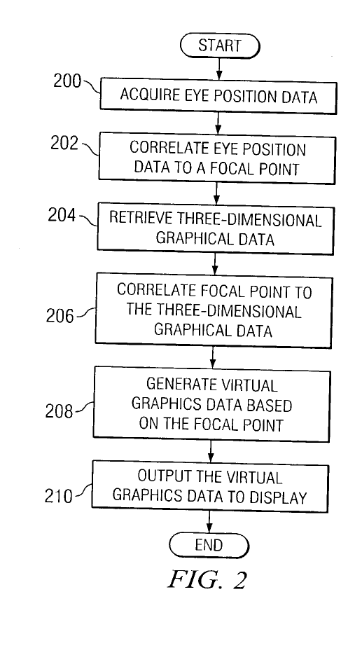

FIG. 2 is a flow chart illustrating an embodiment of a focally-controlled imaging method in accordance with the present invention. The method begins at block 200, where tracking system 46 acquires eye position data 70. For example, as described above, eye position data 70 for a user may be acquired using an optical tracker 22 coupled to a head-mounted tracking device 20. At block 202, registration system 50 correlates eye position data 70 to a particular spatial focal point of the user. For example, as described above, a predetermined quantity of spatial coordinates may be used to correlate positions of the user's eyes to spatial focal points of the user.

At block 204, virtual generator 42 retrieves three-dimensional graphics data 62. At block 206, virtual generator 42 correlates the focal point of the user, as indicated by eye focal data 72, to three-dimensional graphics data 62. At block 208, virtual generator 42 generates virtual graphics data 68 for displaying the three-dimensional image representations on output device 16 to the user. As described above, the virtual representation images are based on eye focal data 72 to represent the user's current spatial focal point. At block 210, display generator 44 controls the output of the three-dimensional virtual representation images to output device 16.

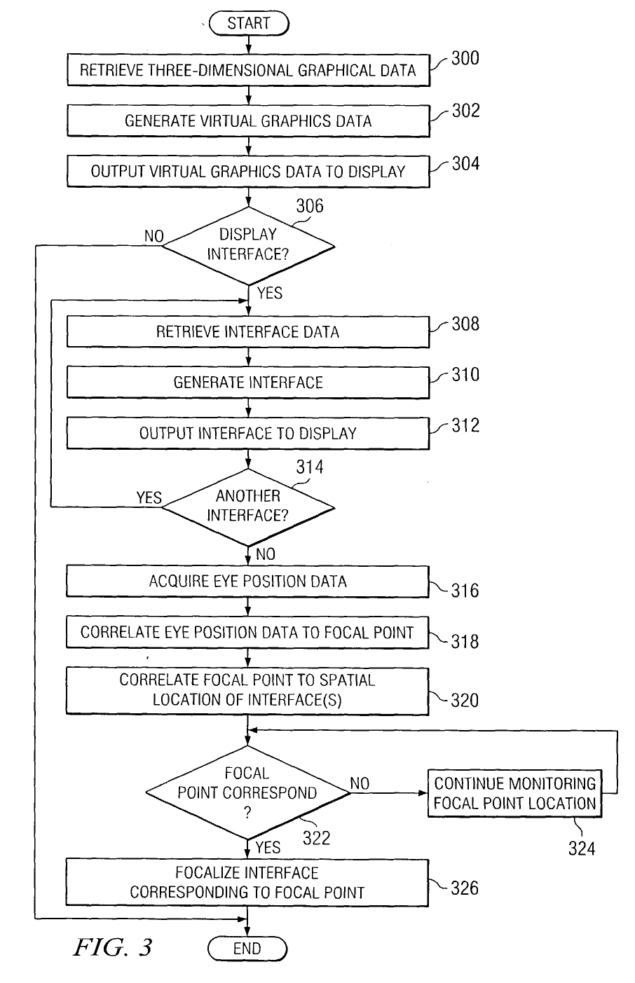

FIG. 3 is a flow diagram illustrating another embodiment of a focally-controlled imaging method in accordance with the present invention. The method begins at block 300, where virtual generator 42 retrieves three-dimensional graphics data 62. At block 302, virtual generator 42 generates virtual graphics data 68 based on three-dimensional graphics data 62 and eye focal data 72. At block 304, display generator 44 controls the display or output of virtual graphics data 68 to output device 16.

At decisional block 306, a determination is made whether display interfaces are to be generated and displayed to the user via output device 16. If display interfaces are to be generated, the method proceeds to block 308, where interface system 48 retrieves interface data 64. At block 310, virtual generator 42 generates the interfaces to be displayed to the user via output device 16. At block 312, display generator 44 controls output of the interfaces to display device 16. At decisional block 314, a determination is made whether another interface requires generation and display. If another interface requires generation and display, the method returns to block 308. If another interface does not require generation and display, the method proceeds from block 314 to block 316.

At block 316, tracking system 46 acquires eye position data 70 from input device 14. At block 318, virtual generator 42 correlates eye position data 70 to a spatial focal point of the user. At block 320, virtual generator 42 correlates the spatial focal point of the user to a displayed spatial location of a particular interface on output device 16. At decisional block 322, a determination is made whether the current spatial focal point of the user corresponds to the displayed spatial location of a particular interface. If the current spatial focal point of the user does not correspond to a displayed spatial location of the interface, the method proceeds to block 324, where virtual generator 42 continues monitoring eye focal data 72 and returns to block 322. If the current spatial focal point of the user does correspond to the displayed spatial location of a particular interface, the method proceeds from block 322 to block 326, where virtual generator 42 modifies the displayed virtual representation images indicated by virtual graphics data 68 and interface generator 80 focalizes the interface corresponding to the current spatial focal point of the user.

Thus, the present invention provides enhanced three-dimensional imaging by focalizing images based on a viewer's spatial focal point. Additionally, interface data screens or displays may be superimposed relative to the three-dimensional representation images and focalized based on the viewer's spatial focal point, thereby enabling greater preception of the interface data screens relative to the underlying representation images. It should be understood that in the methods described in FIGS. 2 and 3, certain steps may be omitted, combined, or accomplished in a sequence different than depicted in FIGS. 2 and 3. Also, it should be understood that the methods depicted in FIGS. 2 and 3 may be altered to encompass any of the other features or aspects of the invention as described elsewhere in the specification.

What is claimed is:

1. A focally-controlled imaging system, comprising:
a tracking system adapted to monitor a spatial focal point of a user; and
a virtual imager adapted to generate a virtual representation of an object for display to the user, the virtual imager adapted to focalize the virtual representation corresponding to the spatial focal point of the user.

2. The system of claim 1, wherein the virtual imager is adapted to focalize one of a plurality of planar interface objects based on the spatial focal point of the user.

3. The system of claim 1, further comprising a head-mounted tracking device adapted to transmit eye position data relating to the user to the tracking system.

4. The system of claim 1, wherein the virtual imager is adapted to transmit the virtual representation to a display environment.

5. The system of claim 1, wherein the virtual imager is adapted to transmit the virtual representation to a head-mounted display device.

6. The system of claim 1, wherein the virtual imager is adapted to generate a two-dimensional data interface objects for superimposition relative to the virtual representation.

7. The system of claim 1, wherein the virtual imager comprises a registration system adapted to correlate eye position data of the user to the spatial focal point.

8. A focally-controlled imaging method, comprising:
obtaining tracking data corresponding to a spatial focal point of a user;
generating a virtual representation of an object for display to the user; and
focalizing the virtual representation corresponding to the spatial focal point of the user.

9. The method of claim 8, further comprising transmitting the virtual representation to a display environment.

10. The method of claim 8, further comprising transmitting the virtual representation to a head-mounted display device.

11. The method of claim 8, wherein obtaining tracking data comprises obtaining eye position data relating to the user.

12. The method of claim 8, wherein focalizing the virtual representation comprises focalizing one of a plurality of planar interface objects based on the spatial focal point of the user.

13. The method of claim 8, further comprising correlating eye position data of the user to the spatial focal point.

14. The method of claim 8, wherein generating the virtual representation of the object comprises generating a two-dimensional data interface object for superimposition relative to the virtual representation.

15. A focally-controlled imaging system, comprising:
means for obtaining eye position data of a user;
means for determining a spatial focal point of the user based on the eye position data; and
means for focalizing a virtual representation of an object for display to the user corresponding to the spatial focal point of the user.

16. The system of claim 15, further comprising means for transmitting the virtual representation of the object to a display environment.

17. The system of claim 15, further comprising means for generating a planar interface object for superimposition relative to the virtual representation.

18. The system of claim 17, wherein the means for focalizing the virtual representation comprises means for focalizing the planar interface object corresponding to the spatial focal point of the user.

19. The system of claim 15, further comprising means for transmitting the virtual representation of the object to a head-mounted display device.

20. The system of claim 15, wherein the means for obtaining the eye position data comprises a head-mounted optical-tracker.
